(19) United States
(12) Patent Application Publication
(10) Pub. No.: US 2012/0328749 A1
(43) Pub. Date: Dec. 27, 2012

(54) CIPC VAPOR TREATMENT

(75) Inventors: John M. Forsythe, Nampa, ID (US); Henry John Duncan, Glasgow (GB); Curtis Lee Eames, Meridian, ID (US)

(73) Assignee: 1,4 GROUP, INC., Meridian, ID (US)

(21) Appl. No.: 13/530,442

(22) Filed: Jun. 22, 2012

Related U.S. Application Data
(60) Provisional application No. 61/499,755, filed on Jun. 22, 2011.

(51) Int. Cl. A23B 7/144

(52) U.S. Cl. 426/318

(57) ABSTRACT

Methods and systems useful for treating crop storage systems with a chemical vapor are set forth herein. Particularly, vapors of CIPC are used in either active or passive systems to inhibit sprouting of stored potatoes.

### CROSS-REFERENCE TO RELATED APPLICATION

This application claims the benefit of U.S. Provisional Patent Application Ser. No. 61/499,755, filed Jun. 22, 2011, the disclosure of which is hereby incorporated herein in its entirety by this reference.

### TECHNICAL FIELD

The instant invention relates generally to treatment of stored crops with active chemicals during storage and especially to sprout inhibition of potatoes during extended storage periods.

### BACKGROUND

Stored potatoes are treated with sprout inhibitors to preserve them from Fall harvest to sale dates many months later. Effective sprout inhibitors, such as CIPC (chloroisopropyl carbamate), have been applied historically as an aerosol. See, e.g., Morgan U.S. Pat. No. 4,887,525, and Forsythe et al. U.S. Pat. Nos. 5,936,660, 6,068,888, and 6,322,002.

Aerosols must be applied before the pile of potatoes compresses. Effective aerosol treatment requires numerous channels through the pile so that there is a high probability of getting crystals/particles of CIPC, for example, on every potato. Early treatment of harvested potatoes within the storage facility with 1, 4 DMN tends to promote/retain turgidity of the potatoes. See U.S. Pat. Nos. 5,965,489, 6,310,004, and 6,375,999 to Forsythe et al. Even under the best of circumstances, the distribution of CIPC tends to be uneven with greater concentrations lower in the pile since the aerosol enters the pile from ducts placed at the floor of the storage facility.

Aerosol treatments are generally about 50 percent useful in depositing CIPC particles on individual potatoes, i.e., at an application dosage of 20 ppm, about 10 ppm is an average deposition upon the treated potatoes. Aerosols provide small particles that adhere to the surface of potatoes. The CIPC aerosols generated by thermofoggers may also contain a mixture of CIPC vapor and submicron particles that are thought to be lost upon the first venting of the storage facility after aerosol treatment. Also, even with a low-airflow application method described in the Morgan patent, some CIPC deposits upon the storage facility superstructure and upon its floor.

Porous particles such as alumina have been infused with chemicals such as 1,4-DMN to form a sachet for placement in boxes of potatoes during shipment, as described in, for example, U.S. Pat. No. 5,918,537. This patent references earlier experimental work of Beveridge and Duncan wherein various chemicals were infused into alumina. However, neither of these references contemplate the use of CIPC as an infused chemical.

For environmental and cost considerations, alternative techniques for more effective use of CIPC are desirable.

### BRIEF SUMMARY OF THE INVENTION

A particular embodiment of the invention includes a method of inhibiting sprouting of potatoes stored in a storage facility, wherein a predetermined quantity of vapor of CIPC is circulated among the stored potatoes.

Another embodiment includes a method of inhibiting sprouting of potatoes in a storage facility with CIPC vapor generated from a predetermined quantity of a sustained release media. The method includes providing a high surface-area to volume media with CIPC embedded therein, and placing the media in an airflow stream within a storage facility.

Another aspect of the invention includes a method of generating vapors from a molten source of CIPC and directing at least some of the vapors into a porous fabric located within a storage facility.

Particular methods also include introducing a predetermined quantity of CIPC vapor into a potato storage facility from pads of a porous fabric infused with solid particles of CIPC.

### BRIEF DESCRIPTION OF THE SEVERAL VIEWS OF THE DRAWINGS

In the drawings, in which various features of embodiments of the present invention are depicted:

FIG. 1 is a diagram of a particular embodiment of an external vapor introduction system;

FIG. 2 is an illustration of an embodiment of a system for permeating a porous fabric with very minute particles of CIPC; and

FIG. 3 is an illustration of an embodiment of an active/passive system for introducing CIPC vapor to a stored pile of potatoes.

### DETAILED DESCRIPTION OF THE INVENTION

A method for treating stored tubers, e.g., potatoes, with CIPC vapor without generation of an aerosol has been developed. Although the partial pressure of solid CIPC, for example, is very low (about 1.0 mg CIPC per cubic meter) at the temperature of potato storage facilities (about 5° C. to 10° C.; about 41° F. to 50° F.), generation of sufficient CIPC vapor to envelop the stored potatoes has been effective in maintaining potatoes in a non-sprouting condition.

In a particular embodiment of the invention, a desirable method for CIPC vapor treatment includes: (1) preventing that a significant concentration of CIPC vapor is present before suberization is complete, typically about 30 days after harvest for most potato varieties; (2) introducing a maximum vapor pressure of CIPC at a storage temperature whenever eyes are first starting to open; (3) providing a rapid recovery of maximum vapor pressure of CIPC after venting of the facility; and (4) providing at least a substantially uniform concentration of CIPC vapor throughout the entire facility or throughout the pile of potatoes.

Generation of CIPC vapor may be from an active system or a passive system. Either type of system may be utilized so long as the above criteria are met.

Active systems, for the purposes of this invention, may include ones in which the rate of CIPC vapor generated per unit of time can be raised and controlled. Active systems can be advantageous to recreate a desired concentration of vapor per unit volume of atmosphere within a storage facility. Active systems are generally self-contained and minimize any cleanup post-storage.

Passive systems may provide a predetermined quantity of CIPC to generate a constant sublimation rate to give an optimum CIPC vapor concentration at the extant storage temperature. Passive systems generally are completely contained within a storage facility, while active systems may be at least partially situated external to the storage facility. Passive systems are generally slow-release systems that provide vapor from exposed surfaces of CIPC. Passive systems may further incorporate a delayed-release characteristic so the passive system may be placed in a storage facility concomitant with the placement of potatoes in the facility but with a predetermined delay of release (exposure) of CIPC until at least suberization of the potatoes is complete or even at a later time period. Passive systems may require a large extended surface of CIPC inasmuch as the vapor pressure via sublimation is very low and a large surface area of chemical is required to generate an appropriate volume of CIPC vapor to achieve optimum concentration of chemical vapor in the storage facility.

### Active Systems

Active systems can use an imposed airflow to pass over or through CIPC to provide CIPC vapor at desired rates. The vapor generation may be continuous or intermittent, depending upon the desired treatment.

One useful active system may involve a pool of molten CIPC through which air is bubbled and introduced into a storage unit. The melting point of CIPC is about 105° F. (about 41° C.), which is relatively easy to achieve. Molten CIPC at 150° F. has a relatively high vapor pressure compared to CIPC at storage temperatures of 40° F. to 50° F. Given this relatively higher vapor pressure, air passed through the molten CIPC can introduce a significant amount of CIPC vapor into a storage facility. This may be very effective at restoring the desired concentration of CIPC vapor in a storage facility after the facility has been vented to purge the facility of accumulated carbon dioxide (CO₂) caused by respiration of the potatoes. Such venting typically expels, generally, all the “headspace” air (gas) in the facility.

Given the relatively small amount of air having a relatively high concentration of CIPC vapor being introduced into the potato pile via an active system, the relatively high temperature of this air will not impart significant thermal energy into the storage facility. Thus, the desired concentration of CIPC vapor can be reintroduced into the storage facility without significantly increasing the temperature of the atmosphere within the facility. Periodic venting of the facility is also done to introduce cool air to maintain a cool temperature within the facility since the respiring potatoes also generate heat.

A vapor generator employing molten CIPC may be external to the storage facility or located in the fan room within the facility. Either internal or external generators may employ air from the storage facility to be bubbled through a molten pool of CIPC. Alternatively, fresh external air may be utilized with either an external or internal generator.

Molten CIPC vapor generators may generally be used intermittently to restore CIPC vapor within a storage facility to a desired concentration immediately after the facility was vented, which usually occurs for only a short period every few days.

The vapor pressure of CIPC at storage temperatures (5° C. to 10° C.) is very low. At about 138° C., the vapor pressure is only about 1 mmHg. However, the vapor pressure increases rapidly when higher temperatures are used to about 14 mmHg at 175° C. (347° F.). The boiling point of CIPC is about 450° F. (also its decomposition temperature), which provides a vapor pressure of 760 mmHg. Thus, the higher the operating temperature of a pool of molten CIPC, the greater the vapor pressure. These factors can be used by an applicator to regulate or modify the vapor pressure of CIPC during an application process.

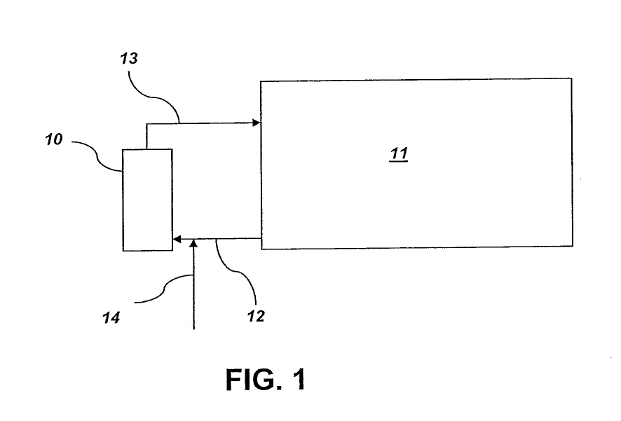

FIG. 1 is a diagram of a particular embodiment of a vapor introduction system for a potato storage facility 11. A CIPC melt tank 10 may include means to maintain CIPC in a molten condition at a temperature of from about 105° F. (melting point of CIPC) to about 400° F. Headspace gas (humid air plus CIPC vapor) may be circulated to the melt tank via line 12 to be bubbled through molten CIPC to create CIPC vapor to be returned to the potato storage facility 11 via line 13. Given that CIPC vapor introduced into the storage facility introduces minimal increase in the headspace pressure within the facility, the use of fresh air 14 may be used to carry CIPC vapor into the storage facility.

The melt tank may be heated with any suitable heat source, such as, for example, natural gas, propane, or an electric heater. Molten CIPC can stay molten for an extended period of time without heat energy being applied if the melt tank is well insulated. For example, no heat energy may be needed for the melt tank while storage facility 11 is vented. Also, heat energy may be required only intermittently during air being bubbled through the molten CIPC, depending upon the rate of air involved.

Given that the vapor pressure of molten CIPC is many times greater than solid CIPC at temperatures common in the storage facility, the rate of airflow through the melt tanks may be relatively low.

### Passive Systems

Passives systems typically have a very high surface area of exposed solid CIPC. Aerosolized particles on potatoes are an example of a passive system, however, the passive systems of this invention do not include aerosolized particles applied directly upon potatoes.

The passive systems of this invention generally involve CIPC adsorbed/absorbed onto or into very small particles of an inorganic material, such as silica gel or alumina, or an organic porous material, such as hemp or burlap. The surface area of CIPC particles/crystals via aerosolization may be approximately 1×10¹⁰ mm² or approximately 1×10⁵ ft². Areas of this magnitude may be readily achieved by adsorption/absorption on either minute silica gel or alumina particles, or upon or within porous fibrous materials.

Silica gel and alumina particles have a very large surface area to volume. Such infused particles could be blown into the floor ducts after suberization of the stored potatoes. Such an approach can permit the circulated air within the storage facility to be continuously passed over and around such particles to carry the CIPC vapor up through the potato pile. Vapor, unlike aerosol particles, does not stick to potatoes and should, therefore, disperse more uniformly throughout the potato pile. The CIPC vapor may, after extended exposure of the potatoes, be absorbed into the skin of potatoes to a very small depth. Ultimately, if such absorption occurs, the vapor pressure of such absorbed CIPC can come to equilibrium with the vapor pressure of CIPC in the headspace atmosphere, given that CIPC vapor presents CIPC molecules to the surface skin of the potatoes. The surface pores in a potato are considerably larger than a CIPC molecule, permitting potential capture of such molecules by the skin.

At such time as the CIPC vapor decreases in concentration in the headspace, the molecules in the potato skin may off-gas CIPC vapor to be effective in inhibiting nascent sprouts.

Given that both silica gel and alumina are inorganic particles, they may be readily vacuumed out of the floor ducts and other storage structures once the potatoes have exited the storage facility. Generally, such particles may be re-infused with CIPC and reused.

The infused particles may be contained in sacks, porous bags, or other suitably porous containers, that are strategically positioned within a storage facility to be exposed to maximum air circulation.

Other passive systems may include adsorption/absorption into/onto porous fibers, such as hemp, burlap, and the like, to permit the use of “blankets” of such infused fiber for exposure to the circulated air (headspace atmosphere).

As indicated herein, both silica gel and alumina particles have a very high surface area per unit volume and per unit of weight. For example, silica gel is reported to have a surface area of 800 square meters per gram (800 m²/g), while alumina is reported to have a surface area of about 325 m²/gm to 355 m²/g, depending upon particle size (325 square meters for a ¼ inch or 6 mm particle and 355 square meters for a ⅛ inch or 3 mm particle).

Both silica gel and alumina are very effective desiccants. Thus, both should preferably be maintained in the driest atmosphere possible before and during infusion of such particles with CIPC. Silica gel is somewhat temperature sensitive with an upper limit of about 325° F. Thus, if silica gel is infused with molten CIPC, the temperature of the molten CIPC should be maintained below about 325° F.

While the surface area per unit volume or weight is very large for both silica gel and alumina, because of the viscosity of infused molten CIPC, it is assumed that the surface area of the CIPC exposed by the particle is about 30 percent to about 60 percent of the reported surface area. Thus, for silica gel, the CIPC surface area may be from about 250 m²/g to about 500 m²/g of silica gel while that for alumina would be from about 100 m²/g to about 200 m²/g. Improved methods for infusing porous media with CIPC are disclosed in copending patent application filed contemporaneously herewith, Ser. Nos. ______ and ______ (Attorney Docket Nos. 1957-10086.2US and 1957-10085.2US).

Given that in a passive system vapor off-gassing via sublimation is a function of surface area, an effective dosage surface area of CIPC should preferably remain available during at least the extended period when the potatoes are attempting to sprout. This period may be from one to ten months. At 42° F., CIPC has a vapor pressure equivalent to about one microgram per liter, thus, equivalent to one milligram/cubic meter. Technical literature indicates that one microgram/liter of CIPC is sufficient to inhibit sprouting of potatoes so long as that concentration is maintained during the period that the potatoes are trying to sprout.

The significant surface area per unit weight (or unit volume) of silica gel and alumina exists because such particles are very porous. However, the size of each pore opening at the surface of each particle can be very small. Any method of infusing CIPC, or other chemical, such as, for example, either silica gel or alumina that “plugs” the pore opening will very significantly reduce the surface area of such particle. A skilled artisan can take these factors into account when infusing chemicals into a media.

Infusion of CIPC via a spray of molten CIPC onto a mass of silica gel o alumina particles will incorporate CIPC into such particles. Even assuming that the size of the spray particles plug some of the pores of silica gel or alumina particles, the reduction of surface area of CIPC available per particle will not negatively affect the improved surface area effect of the CIPC infused media. By way of example, even if the available surface area per particle is only 5 percent of its maximum surface area, such an area (e.g., 5 percent of 800 m²/g for silica gel) is still equal to 40 m²/g, which is a large surface area per unit wt. and volume under such infusion conditions. A surface area of 40 m²/g is 18,160 m²/lb. of silica gel. For alumina, the surface area would be about 40 percent of that, still a very significant surface area.

It is estimated that a surface area of about 1×10⁹ mm² (1×10³ m²), i.e., 1,000 m² of solid CPIC with a thickness averaging about 5 microns at about 40° F. to 50° F. (approximately 5° C. to about 10° C.) is sufficient to maintain one million pounds of potatoes in a non-sprouting condition.

It is known from aerosol treatments of potatoes that an initial deposit of about 10 ppm of CIPC particles (sized about one to 10 microns) evenly distributed throughout a potato pile is sufficient to maintain the potatoes in a non-sprouting condition for about six months. Given the sublimation of the CIPC over a six-month period, the residual CIPC may still be at about 2 ppm, an amount that can generate sufficient CIPC vapor to maintain the potatoes in a non-sprouting condition.

As indicated hereinabove, ten pounds of CIPC delivered as an effective aerosol (1-10 micron sized particles/crystals) is sufficient to maintain one million pounds of potatoes in a non-sprouting condition for six to ten months. The effective total surface area of such minute particles is estimated to be about 1000 m² at an average thickness of about 5 microns.

If silica gel is infused with molten CIPC at a 5 percent effective surface area (40 m²/g), then only 50 g of silica gel would be required to provide such an area. However, this would mean that 50 g of silica gel is holding ten pounds of solid CIPC, wherein the film thickness of the CIPC is, on average, of about 5 microns.

This type of effective surface area may be difficult to achieve given the pore size of the silica gel. Silica gel may have a useful surface area of 800 m²/g as a desiccant, wherein water from humid air is absorbed at a molecular level. Given the large size of a CIPC molecule in comparison to the size of a water molecule, a preferred technique of infusing CIPC into silica gel or alumina is from a vapor (gas) of CIPC to avoid plugging the minute pore opening at the surface of the silica gel or alumina particles.

Another approach for computing the quantity of CIPC vapor to inhibit sprouting is to use the figure of 1 mg/cubic meter concentrate as effective in suppressing sprouting. Thus, for a storage building 200 ft×100 ft×30 ft high (about 18,000 cubic meters), assuming a potato volume of 8000 m³, allows for a headspace of about 10,000 m³. This equates to 10,000 mg of CIPC vapor to effect sprout inhibition. Assuming a venting schedule of every two days or about 15 times per month, a total of 150,000 mg per month would maintain the potatoes in a non-sprouting condition. This equates to about one-third pound of CIPC vapor (1 lb=454 g×1000 mg/g). Thus, one pound of CIPC is 454,000 mg. Therefore, three pounds of CIPC in vapor form would maintain such a storage facility sprout free for six months.

A storage facility of about 20,000 cubic meters could hold upwards of 5 million pounds of potatoes. Even assuming that a CIPC vapor quantity of ten pounds was required, this would be a very significant reduction in CIPC applied compared to aerosol techniques. This quantity does correspond with the knowledge that, at 2 ppm, CIPC via aerosol treatment is sufficient to suppress sprouting. However, in order to have a 2 ppm deposit on potatoes after such aerosol treatment some six months earlier, the initial treatment is intended to deposit about 8 to 10 ppm CIPC on the potatoes. Since generally only about 50 percent of aerosolized CIPC deposits on the potatoes, a quantity of about 100 pounds of aerosolized CIPC would be required to get 50 pounds of CIPC on five million pounds of potatoes in storage, i.e., a deposit of 8 to 10 ppm, which diminishes (via sublimation, etc.) to about 2 ppm over six months' time. Thus, an effective vapor treatment has the potential to reduce CIPC usage as a sprout inhibitor by an amount of from 50 percent to 90 percent.

Given that resistance to gas flow increases as channel size decreases, then high velocity movement of circulating headspace atmosphere may cause the headspace gas to channel through the pile through the most open channels. Thus, vapor treatment may be improved by slowing down the velocity of the circulating headspace gas to allow it to diffuse through the narrowest channels to reach potato surfaces (i.e., eyes that might not be reached otherwise).

It is known from U.S. Pat. No. 4,887,525 (Morgan Patent) that slower circulation of headspace gas is desirable to achieve better distribution of fogged particles on the potatoes. The Morgan technique has become standard practice for the past 20 years in the United States. Thus, in order to provide good vapor distribution throughout a potato pile, and especially in box stores where high-speed gas channels between boxes, it may be preferred to reduce the circulation rate of the fans below the normal rate. However, sufficient circulation should be provided to effect proper temperature control within a potato pile and to sweep “pockets” of CO₂ into the headspace for proper venting.

Although inorganic porous media, e.g., silica gel and silica, offer large surface areas useful in the instant invention, porous fabric media may, in many instances, be preferred as carriers for a solid CIPC having an extensive surface area.

Porous fabrics suitable for use in the invention include, for example, hemp, jute, burlap, etc., which, in many instances, may be discarded bags or containers from shipment of potatoes. Thus, such fabric media may be essentially cost free except for collection, shipment and cleaning of such discarded fabric. Such fabrics, even if purchased new, are relatively inexpensive.

CIPC could be introduced to such fabrics in several different ways. CIPC, whether from a solution or from a molten liquid, could be thermally fogged onto such porous fabric in an enclosed chamber to preclude escape of any fogged CIPC. The porous fabric could be formed into a tent-like enclosure to capture essentially all the CIPC particles constituting the fog.

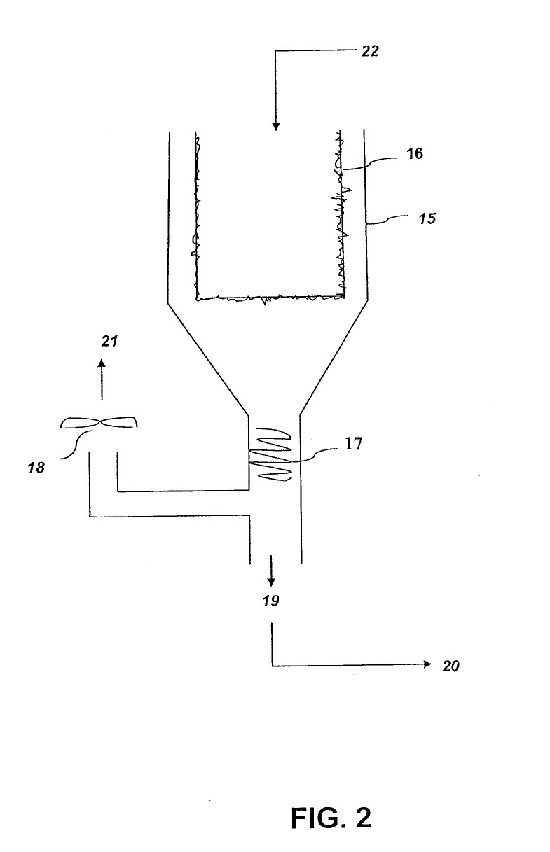

A representative chamber 15 suitable for infusing porous media with fogged CIPC 22 is illustrated in FIG. 2. The porous media 16 may be several plies thick so that essentially all CIPC particles are captured. Thermofogging may produce vapor of CIPC that may pass through even several plies of porous fabric. Such fogged CIPC 22 vapor may be captured by having condensing coils 17 downstream of the tent of the porous media 16. CIPC vapor forming condensate 19 upon such condensing coils 17 can be recovered by subsequent cleansing of the condensing coils 17 with a suitable solvent. Such dissolved CIPC may be recovered by evaporation of the solvent or used as a solution of CIPC in an acceptable solvent such as methanol, 1,4 DMN, clove oil, carvone or other essential oils. The recovered CIPC may be recycled via recycle stream 20. Such a solution in appropriate quantities could even be admixed with molten CIPC to be thermofogged into a tent of porous fabric. An exhaust fan 18 is connected to the condensation discharge line to exhaust clean air 21 to the atmosphere. The condensate 19 of CIPC may be reused via recycle stream 20.

The porous fabric infused with CIPC particles may be presented to a pile of potatoes, whether in bulk form or contained in boxes, in several ways. The infused fabric may, for example, be hung in front of the circulation fans of a modern storage facility so that virtually all of the circulating air within the storage facility will pass through or over the infused fabric. Such an approach would accomplish several objectives: 1) expose the maximum surface area of infused particles to a steady stream of air to enhance maximum rate of sublimation; 2) slow down the air circulation rate so that diffusion of CIPC vapor could effectively occur within a pile of potatoes or within a box of potatoes; and 3) pass the CIPC vapor through and around the potatoes before recirculation through the fans, thereby exposing the potatoes to air having the maximum concentration of CIPC vapor.

Additionally, the porous fabric may be in the form of a rope-like structure with a delayed release aspect where such rope-like structure may be placed in piles or boxes of potatoes as the storage facility is being filled. Additionally, porous canisters may be filled with porous media infused with CIPC and having a delayed-release aspect whereby such canisters can be placed in piles or boxes of potatoes as the potatoes are being introduced into a potato storage facility.

Further porous fabric or ropes, canisters and the like, having been infused with small particles of CIPC, may be placed in storage facility plenums, ductwork and the like after the storage facility has been loaded. The CIPC particles need not be coated with any delayed release coating, but may have an extended surface available for immediate sublimation of CIPC. Such infused porous fabric can be hung in the storage facility after suberization of the potatoes has occurred.

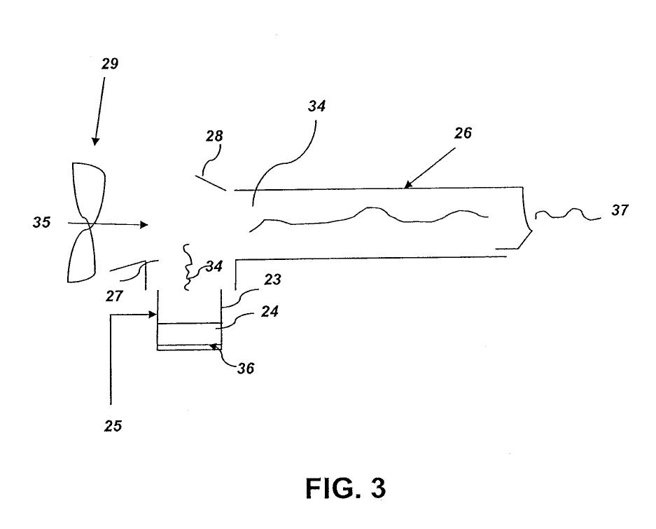

A particular embodiment of an active/passive vapor treatment system is illustrated in FIG. 3. The system includes one or more hot pots (melt tanks) 23 which may be situated in front of the storage facility circulation fans 29. The one or more hot pots 23 may include a heating element 36, such as an electric heater, capable of heating the CIPC to its molten state. Molten CIPC 24, for example, may be within the hot pot to give off CIPC vapor 34. Compressed air 25 may, optionally, be introduced into the molten CIPC 24 to facilitate the generation of significant quantities of CIPC vapor 34. The CIPC vapor 34 may flow into a chimney-like structure 26 positioned substantially laterally above the hot pot 23 with an access opening 27 for hot CIPC vapors 34 and an opening 28 to admit airflow 35 from the storage facility circulation fans 29. CIPC vapors 34 may then be directed upward into the fabric chimney 26 to be carried by circulating air through the chimney (positioned similar to a wind sock) to flow into the plenum 37 of a storage facility to be further distributed through a pile of stored potatoes.

To the extent some of the CIPC vapor condenses or crystallizes upon the chimney fabric, such condensate or crystals may act as an extended surface of CIPC from which CIPC vapor may be subsequently generated by sublimation, i.e., present a passive system.

Operation of certain molten CIPC hot pots has, at times, resulted in crystals forming at or near the outlet of the hot pot. The system illustrated in FIG. 3 preferentially has an air stream introduced into the molten CIPC to carry the vapors of CIPC away from the hot pot and into the fabric chimney so that any CIPC crystals formed in or on the porous fabric of the chimney will be useful as a source of CIPC vapor via sublimation.

Positioning the porous fabric chimney in a substantially horizontal position in front of the storage facility circulation fans permits the circulation air to contact the CIPC vapor immediately above the CIPC hot pot to propel the vapor through the chimney and into the plenum of the storage facility to boost vapor concentration rapidly in the headspace atmosphere after venting of the facility. Alternatively, the porous fabric chimney can be positioned behind the storage facility circulation fans.

An active/passive system, such as that illustrated in FIG. 3, may be monitored and controlled remotely, by telemetry, if desired.

Control may be exerted over the temperature of the molten CIPC and/or the flow rate of air passing over or through the molten CIPC to facilitate vaporization as well as the speed of the circulation fans.

Given the implementation of monitoring and controlling various aspects of the system by telemetry, a central control station can be established to monitor and control numerous storage facilities.

What is claimed is:

1. A method of inhibiting sprouting of potatoes stored in a storage facility comprising circulating among said potatoes a predetermined quantity of vapor of CIPC.

2. The method of claim 1, wherein said vapor is generated from a source external to said storage facility.

3. The method of claim 1, wherein said vapor is generated from a source internal to said storage facility.

4. The method of claim 1, wherein said vapor is generated from CIPC in solid form.

5. The method of claim 1, wherein said vapor is generated from CIPC in liquid form.

6. The method of claim 1, wherein the temperature within said storage facility is maintained at about 5° C. (about 40° F.) to about 12° C. (about 55° F.).

7. The method of claim 1, wherein the relative humidity within said storage facility is maintained at least 90 percent.

8. A method of inhibiting sprouting of potatoes in a storage facility with CIPC vapor generated from a predetermined quantity of a sustained release media comprising a high surface area to volume media with CIPC embedded therein, said media enhancing sublimation of the embedded CIPC, said media placed in the airflow stream within a storage facility.

9. The method of claim 8, wherein said media is an inorganic porous material.

10. The method of claim 8, wherein said media is an organic porous (absorbent/adsorbent) material.

11. A method of generating vapors from a molten source of CIPC and directing at least some of said vapors into a porous fabric located within said storage facility.

12. The method of claim 11 wherein said molten source of CIPC is located within said storage facility.

13. The method of claim 11 wherein the porous fabric is in the form of a hollow column through which said CIPC vapor is directed.

14. The method of claim 13 wherein said hollow column has a vapor inlet opening proximate a storage facility fan.

15. A method of introducing a predetermined quantity of CIPC vapor into a potato storage facility from pads of a porous fabric infused with solid particles of CIPC.

16. The method of claim 15 wherein the solid particles of CIPC are derived from an aerosol of CIPC.

17. The method of claim 15 wherein the pads of a porous fiber contain porous inorganic media having an extended surface per unit volume, wherein said porous inorganic media have a thin coating of CIPC upon its extended surface.

18. The method of claim 15 wherein the pads are in the form of a rope-like structure.
